(19) United States
(12) Patent Application Publication
(10) Pub. No.: US 2011/0235010 A1
(43) Pub. Date: Sep. 29, 2011

(54) EXPOSURE APPARATUS AND IMAGE FORMING APPARATUS

(75) Inventor: Yoshiya IMOTO, Ebina (JP)

(73) Assignee: FUJI XEROX CO., LTD., Tokyo (JP)

(21) Appl. No.: 12/838,887

(22) Filed: Jul. 19, 2010

(30) Foreign Application Priority Data
Mar. 25, 2010 (JP) 2010-071092

(51) Int. Cl. G03B 27/54

(52) U.S. Cl. 355/67

(57) ABSTRACT

An exposure apparatus includes: a scanning optical system; a light concentrating section that concentrates lights by the scanning optical system on the photosensitive surface and adjusts a light concentrating position to a light traveling direction; a light receiving device to which lights having different light sources are guided and emitted from a part of a light movement range with scanning to receive separately the lights, including light receiving parts to detect a received light quantity, where an optical path length to the light receiving part is greater than that to the photosensitive surface for a part of the lights passing through on the light receiving parts and is smaller for another part of the lights; and a light concentrating position adjusting section that uses the function of the light concentrating section to adjust the light concentrating position by the light concentrating section based on the received light quantity.

### CROSS-REFERENCE TO RELATED APPLICATION

This application is based on and claims priority under 35 USC 119 from Japanese Patent Application No. 2010-071092, filed Mar. 25, 2010.

### BACKGROUND

### (i) Technical Field

The present invention relates to an exposure apparatus and an image forming apparatus.

### SUMMARY

According to one aspect of the present invention, there is provided an exposure apparatus including:

plural light sources each of which emits light;

a scanning optical system that guides the lights emitted from the plural light sources to a photosensitive surface included in a photoreceptor which includes the photosensitive surface on which an image is drawn by receiving emission of light and in which at least the photosensitive surface moves in a first direction along the photosensitive surface, to scan the photosensitive surface in a second direction crossing the first direction by each of the lights, and that guides plural lights whose light sources are different from one another to positions different from one another in the first direction on the photosensitive surface;

a light concentrating section that concentrates the lights which are emitted from the plural light sources and which are guided to the photosensitive surface by the scanning optical system, on the photosensitive surface, and that also has a function to adjust a light concentrating position to a light traveling direction;

a light receiving device to which plural lights whose light sources are different from one another are guided and emitted from a part of a movement range of light that moves along with scanning by the scanning optical system so as to receive separately the plural of lights, which includes plural light receiving parts to detect a received light quantity of each of the lights, and in which an optical path length to the light receiving part is greater than the optical path length to the photosensitive surface as for a part of the plural lights that pass through on the plurality of light receiving parts along with the scanning, and the optical path length to the light receiving part is smaller than the optical path length to the photosensitive surface as for another part of the plural lights; and

a light concentrating position adjusting section that uses the function of the light concentrating section to adjust the light concentrating position by the light concentrating section based on the received light quantity detected by each of the plural light receiving parts included in the light receiving device.

### BRIEF DESCRIPTION OF THE DRAWINGS

Exemplary embodiments of the present invention will be described in detail based on the following figures, wherein:

FIG. 1 is a schematic block diagram of an image forming apparatus;

FIG. 2 is a schematic block diagram of a laser exposure device;

FIG. 3 is a diagram illustrating a state of a cylinder mirror, etc. when viewed in a direction of an arrow X illustrated in FIG. 2;

FIG. 4 is a schematic diagram illustrating a positional relationship between a reflective mirror and a focusing detection sensor;

FIG. 5 is a diagram illustrating a concentrate state of laser exposure light;

FIG. 6 is a diagram illustrating a concentrate state of laser exposure light;

FIGS. 7A, 7B, and 7C are diagrams illustrating light intensity detected by a focusing detection sensor;

FIGS. 8A, 8B, and 8C are diagrams illustrating a change in light intensity detected in each area on a sensor surface when laser light focused on the sensor surface at the factory shipment becomes outside the focus due to the temperature in the apparatus; and

FIGS. 9A, 9B, and 9C are diagrams illustrating a change in light intensity detected in each area on a sensor surface when laser exposure light focused on the sensor surface at the factory shipment becomes inside the focus due to the temperature in the apparatus.

### DETAILED DESCRIPTION

An exemplary embodiment of an image forming apparatus of the present invention will be described below with reference to the drawings.

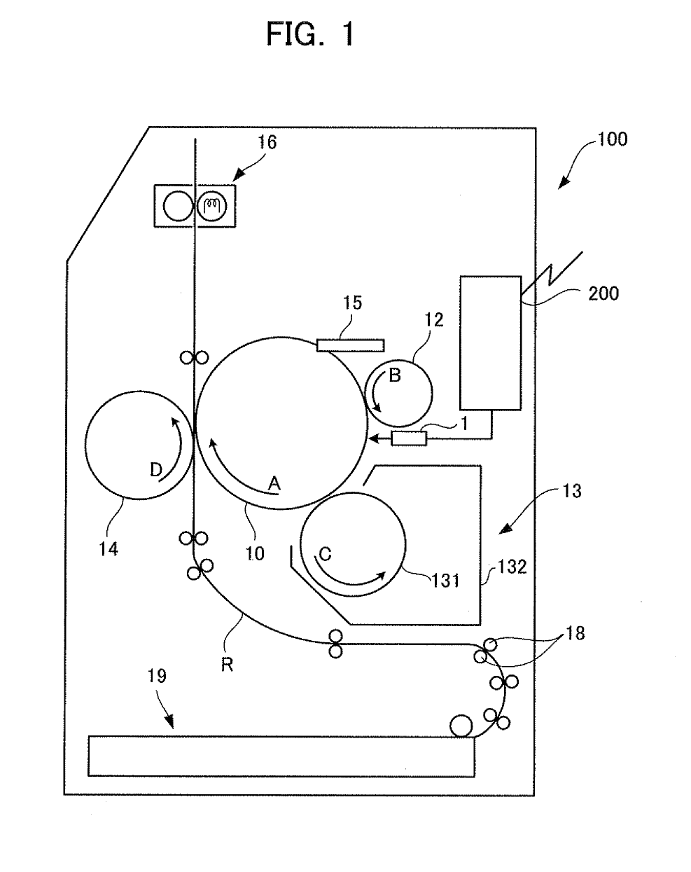

FIG. 1 is a schematic block diagram of an image forming apparatus.

An image forming apparatus 100 illustrated in FIG. 1 has a photoreceptor roll 10 that rotates in an arrow A direction, a charging roll 12 that contacts the photoreceptor roll 10 while rotating in an arrow B direction to apply a predetermined charge to a surface of the photoreceptor roll 10, a laser exposure device 1 that emits laser exposure light on the surface of the photoreceptor roll 10 applied with the predetermined charge to form an electrostatic latent image to be the base of an image, a developing device 13 that develops the electrostatic latent image formed by the laser exposure device 1 by a toner in a developer including the toner and a magnetic carrier, a transfer roll 14 made of urethane foam that rotates in an arrow D direction to transfer a toner image formed by the toner development by the developing device 13 to a recording sheet transferred from a sheet feeding cassette 19 along a transport path R, a cleaning blade 15 that scrapes out the residue remaining on the photoreceptor roll after the toner image is transferred, a transport roll group 18 that transports the recording sheet along the transport path R, and a fixing device 16 that heats and pressurizes the recording sheet with the toner image to fix the toner image on the recording sheet.

The developing device 13 holds a development roll 131 therein that rotates in an arrow c direction and houses the developer including the toner and the magnetic carrier. The magnetic carrier is charge providing particles that frictionally charge the toners by the friction with the toner and is also magnetic particles. The developing device 13 stirs the developer housed inside and frictions the toner and the magnetic carrier by the stirring. As a result of the friction, the toner is negatively charged, and the magnetic carrier is positively charged. Therefore, the toner and the magnetic carrier are electrically adsorbed and mixed together in the developing device 13. The development roll 131 transports the developer to an area between the development roll 131 and the photoreceptor roll 10 while rotating opposite the photoreceptor roll 10.

Although described in detail below, the image forming apparatus 100 illustrated in FIG. 1 also has a control section 200 that controls emission of laser exposure light emitted from the laser exposure device 1 based on an image signal received from the outside.

A flow of an operation of image formation in the image forming apparatus 100 illustrated in FIG. 1 will be simply described.

The charging roll 12 that rotates in contact with the surface of the photoreceptor roll 10 applies a background electrical potential to the photoreceptor roll 10 that rotates in the arrow A direction. When the laser exposure light generated by the laser exposure device 1 in accordance with an image signal transmitted from the outside is emitted on the surface of the photoreceptor roll 10 applied with the background electrical potential so that the electricity of the surface of the photoreceptor roll 10 is eliminated, the potential of the part where the electricity is eliminated becomes an image electrical potential with respect to the background electrical potential. According to the background electrical potential and the image electrical potential, an electrostatic latent image is formed on the surface of the photoreceptor roll 10. The developing device 13 develops the latent image by the toner and forms a toner image on the photoreceptor roll 10. The transfer roll 14 transfers the toner image onto a sheet transported along the transport path R. The toner image transferred onto the sheet is pressurized and fixed on the sheet by the fixing device 16. This completes the simple description of the flow of image formation in the image forming apparatus 100 and the operations of each section.

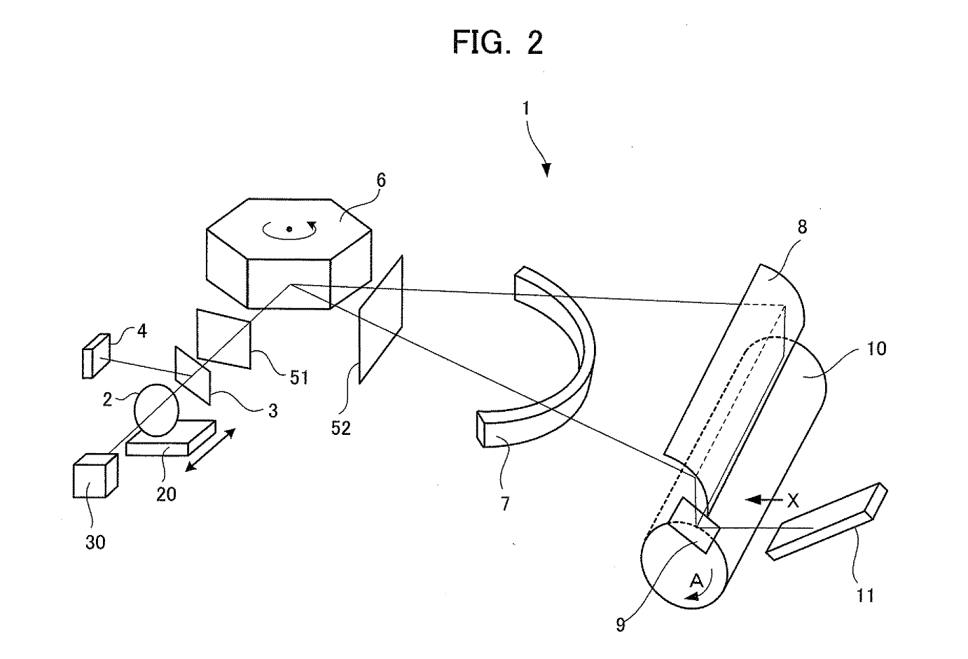

FIG. 2 is a schematic block diagram of a laser exposure device.

The laser exposure device 1 illustrated in FIG. 2 has a semiconductor laser array 30, a focus adjustment mechanism 20, a collimation lens 2 placed on the focus adjustment mechanism 20, a half mirror 3, a light quantity monitor 4, first and second face tilt correction optical systems 51 and 52, a polygon mirror 6, an fθ lens 7, and a cylinder mirror 8. Hereinafter, a direction in which the rotation axis of the photoreceptor roll 10 extends will be referred to as a main-scanning direction, and a direction of the arrow A in which the photoreceptor roll rotates will be referred to as a sub-scanning direction.

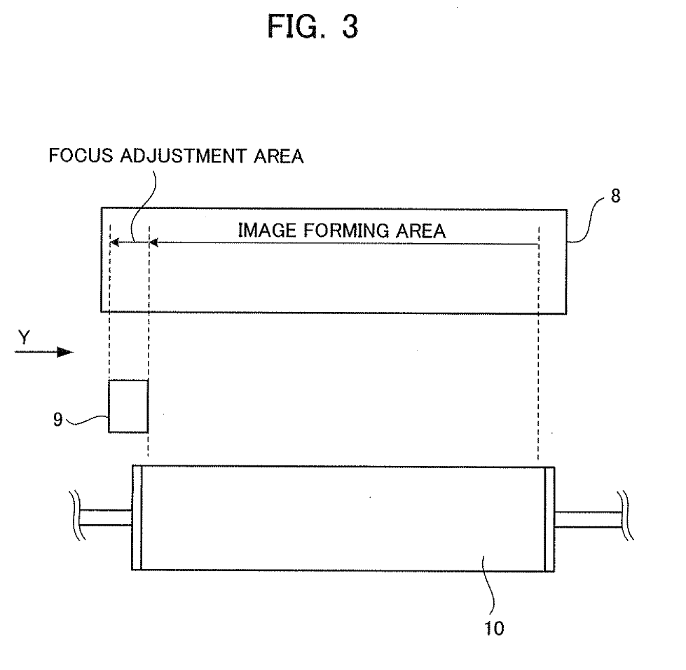

The semiconductor laser array 30 is formed by twelve semiconductor elements two-dimensionally arranged without overlapping with each other in a vertical direction (three lines) and in a horizontal direction (four lines) when viewed from front. Laser light emitted from the semiconductor laser array 30 is diverging light which becomes parallel light after passing through the collimation lens 2. The light quantity monitor 4 controls the laser light quantity to a constant light quantity through the half mirror 3. The first and second face tilt correction optical systems 51 and 52 adjust the tilt of the laser light that has become the parallel light, and the fθ lens 7 collects the laser light in the main-scanning direction. The cylinder mirror 8 further collects the laser light in the sub-scanning direction, and the laser light becomes converging light to be formed as an image by twelve pixels on the photoreceptor roll 10 lined up in the sub-scanning direction. The converging light is also scanning light to scan a range (see FIG. 3) longer than the photoreceptor roll 10 in the main-scanning direction by the polygon mirror 6 that rotates in the direction of the arrow.

The image forming apparatus 100 also has a reflective mirror 9 that is arranged at one end in a scanning range of the laser exposure light scanning in the main-scanning direction and that reflects the laser exposure light that reaches the one end into the sub-scanning direction and a focusing detection sensor 11 that receives part of the laser exposure light reflected by the reflective mirror 9. The semiconductor laser array 30 is equivalent to an example of the light source of the present invention, and a combination of the first and second face tilt correction optical systems 51, 52, and the polygon mirror 6 is equivalent to an example of the scanning optical system of the present invention. A combination of the collimation lens 2, the fθ lens 7, the cylinder mirror 8, and the focus adjustment mechanism 20 is equivalent to an example of the light collecting section of the present invention, and the focusing detection sensor 11 is equivalent to an example of the light receiving device of the present invention. The control section 200 is equivalent to an example of the light collecting position control section of the present invention, and the reflective mirror 9 is equivalent to an example of the light guiding section of the present invention.

FIG. 3 is a diagram illustrating a state of a cylinder mirror, etc. when viewed in a direction of an arrow X illustrated in FIG. 2.

The image forming apparatus 100 periodically adjusts the focus during the image forming operation. Although described in detail below, this is performed by, for the cylinder mirror 8 including an image forming area equivalent to the width of the photoreceptor roll 10 and a focus adjustment area arranged outside the image forming area, directing the laser exposure light that scans the focus adjustment area to the reflective mirror 9 illustrated in FIG. 3. Although the laser exposure light to scan the image forming area is flashing light based on an image signal, the laser exposure light for scanning the focus adjustment area is constant light irrelevant to the image signal.

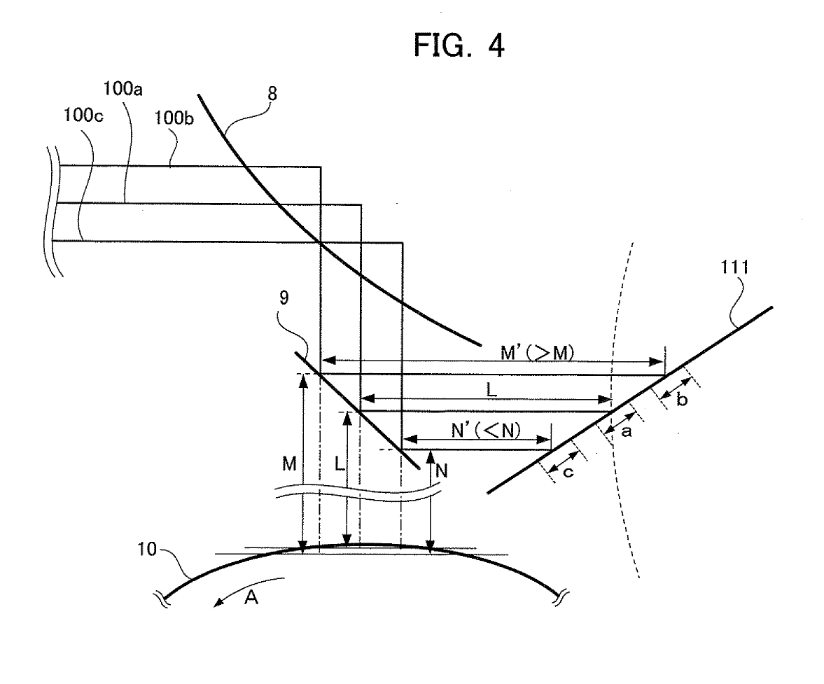

FIG. 4 is a schematic diagram illustrating a positional relationship between a reflective mirror and a focusing detection sensor.

FIG. 4 illustrates the reflective mirror 9 illustrated in FIG. 2 and a sensor surface 111 of the focusing detection sensor 11 when viewed in a direction of an arrow Y illustrated in FIG. 3.

Among the laser exposure lights emitted from each position of the semiconductor laser array 30, FIG. 4 representatively illustrates only three laser lights 100a, 100b, and 100c received by three light receiving areas a, b, and c arranged on the sensor surface 111 of the focusing detection sensor 11.

If there is no reflective mirror 9, the three laser lights 100a, 100b, and 100c are aligned up in the sub-scanning direction on the photoreceptor roll and focused. The sensor surface 111 illustrated in FIG. 4 obliquely opposes the reflective mirror 9. As for the laser light 100a, in which the distance from the reflective mirror 9 to the surface of the photoreceptor roll 10 is a distance L, the distance from the reflective mirror 9 to the sensor surface 111 is the distance L, which is the same distance from the reflective mirror 9 to the surface of the photoreceptor roll 10. As for the laser light 100b, in which the distance from the reflective mirror 9 to the surface of the photoreceptor roll 10 is a distance M, the distance from the reflective mirror 9 to the sensor surface 111 is a distance M′, which is longer than the distance from the reflective mirror 9 to the surface of the photoreceptor roll 10. As for the laser light 100c, in which the distance from the reflective mirror 9 to the surface of the photoreceptor roll 10 is a distance N, the distance from the reflective mirror 9 to the sensor surface 111 is a distance N′, which is shorter than the distance from the reflective mirror 9 to the surface of the photoreceptor roll 10.

Since the image forming apparatus 100 uses a semiconductor laser array 30 of red color, the depth of focus is shallow, and the focus is easily missed depending on the temperature in the apparatus. Therefore, the image forming apparatus 100 obtains quick focus adjustment described below in a simple configuration of guiding the laser exposure light emitted from the semiconductor laser array 30 to the focusing detection sensor 11 through the reflective mirror 9 illustrated in FIG. 4.

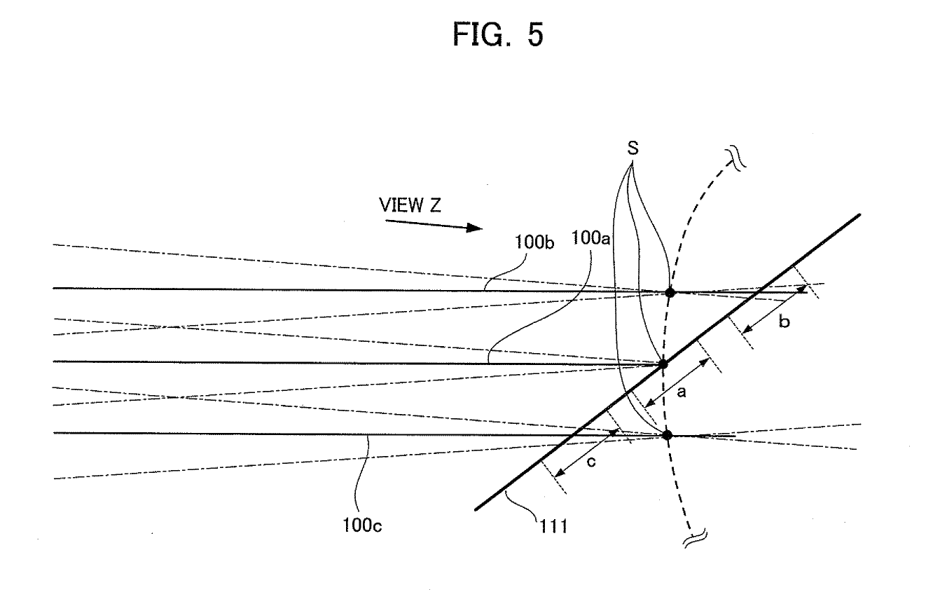

FIG. 5 is a diagram illustrating a concentrate state of laser exposure light.

FIG. 5 illustrates in detail a concentrate state of the three laser lights 100a, 100b, and 100c illustrated in FIG. 4 in the sensor surface 111 of the focusing detection sensor 11. As described above, each laser light includes a focal point S on the surface of the photoreceptor roll 10 illustrated by a dotted line in FIG. 5. FIG. 5 illustrates that only the laser light 100a in the middle of the three laser lights is focused on the sensor surface 111. FIG. 5 also illustrates that the laser exposure light 100b in the top of the three laser exposure lights 100a, 100b, and 100c is outside the focus on the sensor surface 111 and that the laser exposure light 100c in the bottom is inside the focus on the sensor surface 111.

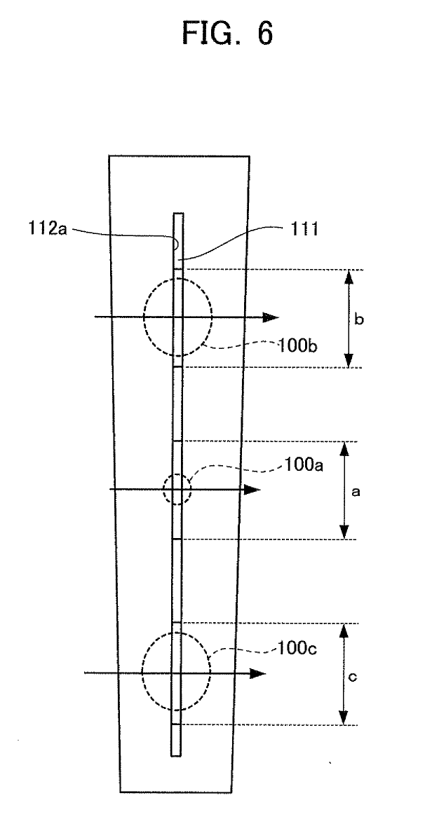

FIG. 6 is a diagram illustrating a concentrate state of laser exposure light.

FIG. 6 illustrates that the width of the light receiving photodiode array on the sensor surface 111 is constant in the beam scanning direction.

FIG. 6 also illustrates beam spots that line up in the sub-scanning direction and that are formed when the three laser lights 100b, 100a, and 100c for scanning in the main-scanning direction shown by arrows from left to right in FIG. 6 pass through a light receiving area window 112a. The middle laser exposure light 100a of the three laser lights 100b, 100a, and 100c is focused on the sensor surface 111. Therefore, the spot diameter illustrated in FIG. 6 is smaller than the spot diameters illustrated in the top and bottom.

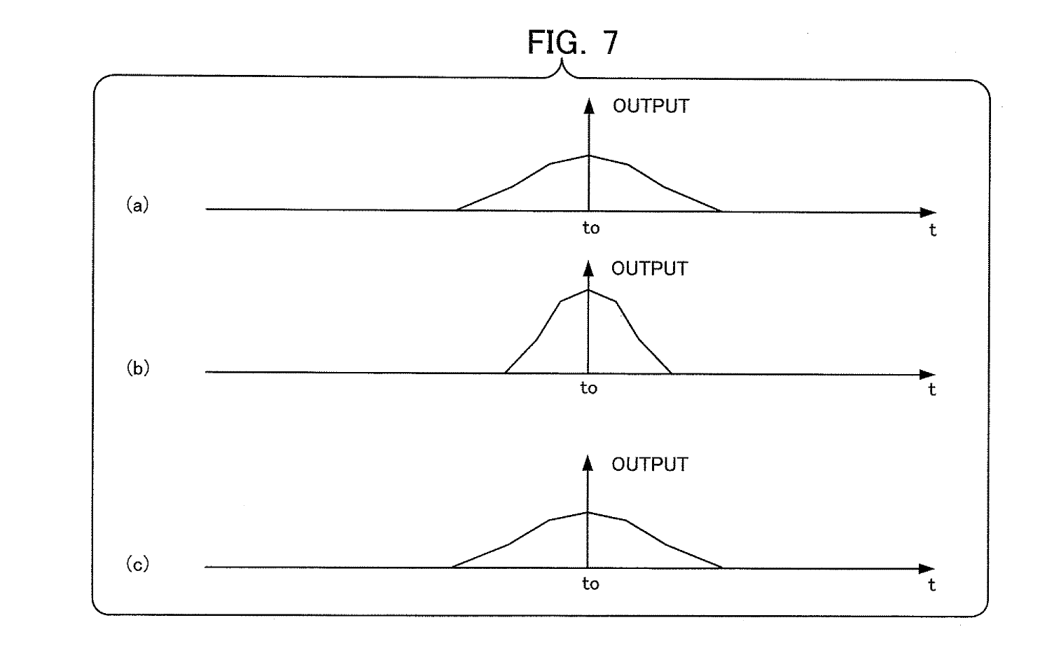

FIGS. 7A, 7B, and 7C are diagrams illustrating light intensity detected by a focusing detection sensor.

FIGS. 7A, 7B, and 7C illustrate received light intensity (vertical axis) at each time (horizontal axis) of the three laser lights 100a, 100b, and 100c that reach the light receiving areas a, b, and c of the sensor surface 111, respectively, through the light receiving area window 112a. From the top to the bottom in FIGS. 7A to 9C, the received light intensity at each time in the light receiving areas b, a, and c illustrated from the top to the bottom in FIG. 6 is illustrated, respectively.

Although the three laser lights 100a, 100b, and 100c do not pass through at the same time, the time that the light passes through the center of the light receiving area window 112a in each area is set as time to.

Among the three laser lights 100a, 100b, and 100c, the spot diameters of the laser light 100b, which is outside the focus in the light receiving area b of the sensor surface 111, and the spot diameters of the laser light 100c, which is inside the focus in the light receiving area c of the sensor surface 111, are greater than the spot diameter of the laser light 100a focused in the light receiving area a of the sensor surface 111. Therefore, as illustrated in FIGS. 7A to 7C, the laser light 100b outside the focus and the laser light 100c inside the focus start to reach the corresponding light receiving areas b and c on the sensor surface significantly before the time to when the centers of the beam spots of the laser lights pass through the center of the light receiving area window 112a. On the other hand, the detection of the laser light 100a focused on the sensor surface 111 in the light receiving area a starts significantly close to the time t0 compared to the laser light 100b outside the focus and the laser light 100c inside the focus.

As illustrated in FIGS. 7A to 7C, as for the maximum light intensity detected in the areas a, b, and c of the sensor surface 111 at the time t0 when the centers of the spots of the laser lights pass through the center of the light receiving area window 112a, the maximum light intensity of the laser light 100a in the middle focused on the sensor surface is greater than the maximum light intensity of the laser light 100b in the top outside the focus and the lower laser light 100c inside the focus on the sensor surface, by a portion that the spot diameter is smaller. The image forming apparatus 100 is adjusted at the stage of factory shipment so that the laser light 100a of the three laser lights 100a, 100b, and 100c is focused on the light receiving area a of the sensor surface 111. The magnitude relationship between the maximum intensity on that occasion, the received light intensity in the light receiving area b, and the maximum received light intensity in the light receiving area c (the same in this case) is stored in a memory (not illustrated). The three laser lights 100a, 100c, and 100b are equivalent to examples of the first light, the second light, and the third light of the present invention, respectively.

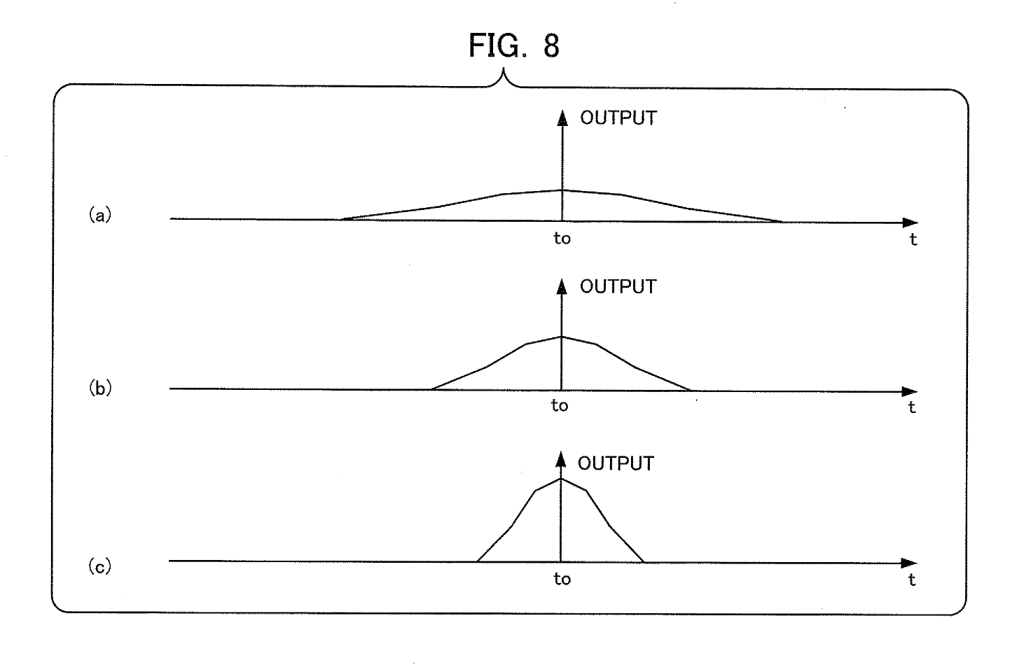

FIGS. 8A, 8B, and 8C are diagrams illustrating a change in light intensity detected in each area on a sensor surface when laser light focused on the sensor surface at the factory shipment becomes outside the focus due to the temperature in the apparatus.

As the laser light 100a illustrated in the middle that is in a focused state on the sensor surface becomes outside the focus, the spot diameter of the laser exposure light 100a becomes large, and the spot diameter of the laser light 100c illustrated in the bottom that is inside the focus becomes small. The spot diameter of the laser exposure light 100b illustrated in the top that is outside the focus becomes greater.

As a result, even though the maximum light intensity detected by the light receiving sensor c in the bottom and the maximum light intensity detected by the light receiving sensor a in the top are the same at the factory shipment, if the maximum light intensity detected by the lower sensor becomes greater than the maximum light intensity detected by the upper sensor as illustrated in FIGS. 5A, 8B, and 8C, it is determined that the focus is changed to outside the focus, and the focus adjustment mechanism 20 is moved inside the focus to correct the missed focus. The movement of the focus adjustment mechanist 20 is continued until the maximum light intensity detected in the light receiving area a of the sensor surface 111 is substantially the same value as the value stored in the memory.

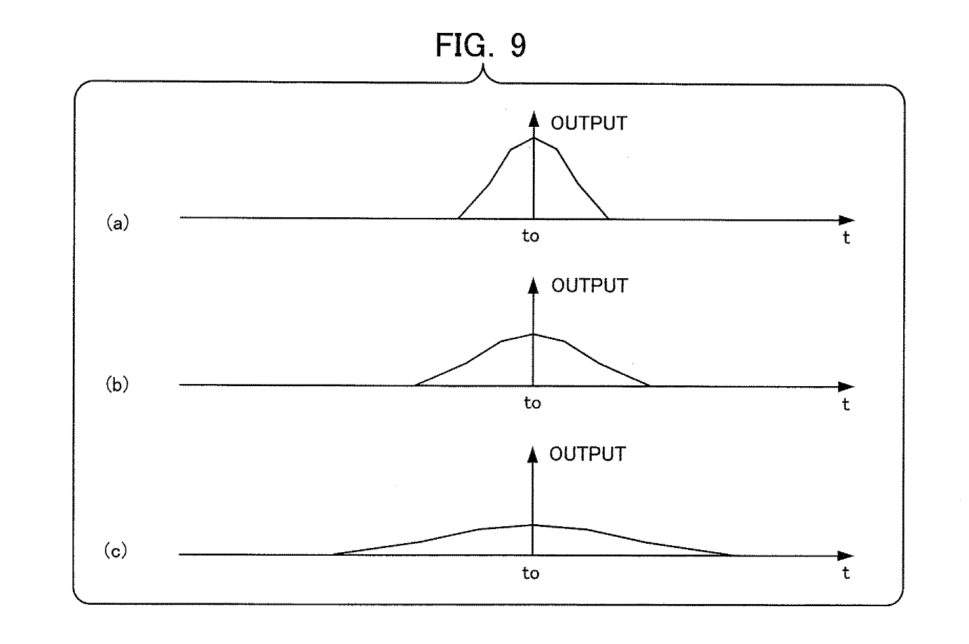

Meanwhile, FIGS. 9A, 9B, and 9C are diagrams illustrating a change in light intensity detected in each area on a sensor surface when laser exposure light focused on the sensor surface at the factory shipment becomes inside the focus due to the temperature in the apparatus.

As the laser light 100a illustrated in the middle that in a focused state on the sensor surface becomes inside the focus, the spot diameter of the laser light 100a becomes large, and the spot diameter of the laser light 100c illustrated in the bottom that is inside the focus becomes greater. The spot diameter of the laser light 100b illustrated in the top that is outside the focus becomes small.

As a result, even though the maximum light intensity detected by the light receiving sensor c in the bottom and the maximum light intensity detected by the light receiving sensor a in the top are the same at the factory shipment, if the maximum light intensity detected by the sensor in the top is greater than the maximum light intensity detected by the sensor in the bottom as illustrated in FIGS. 9A, 9B, and 9C, it is determined that the focus has changed to inside the focus, and the focus adjustment mechanism 20 is moved outside the focus to correct the missed focus. The movement of the focus adjustment mechanism 20 is continued until the detected light intensity of the sensor in the middle is greater than the detected light intensity of the sensor in the top and the sensor in the bottom, and the ratio between the detected light intensity of the sensor in the top and the detected light intensity of the sensor in the bottom is within a predetermined rate (for example, 0.8 to 1.2).

Although three laser lights are explained an example of the plurality of lights of the present invention in the description of the exemplary embodiment, the plurality of lights of the present invention may be two laser exposure lights, laser exposure light inside the focus and laser exposure light outside the focus, on the focusing detection sensor 11.

Although an example of guiding the laser exposure light to the focusing detection sensor 11 through the reflective mirror 9 has been described in the exemplary embodiment, if there is no design restriction, the light is not necessary to be guided through the reflective mirror 9 in the present invention as long as two laser exposure lights, the laser exposure light inside the focus and the laser exposure light outside the focus on the focusing detection sensor, reach the focusing detection sensor 11, and the focusing detection sensor 11 may directly receive the light.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The exemplary embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

1. An exposure apparatus comprising:
a plurality of light sources each of which emits light;
a scanning optical system that guides the lights emitted from the plurality of light sources to a photosensitive surface included in a photoreceptor which includes the photosensitive surface on which an image is drawn by receiving emission of light and in which at least the photosensitive surface moves in a first direction along the photosensitive surface, to scan the photosensitive surface in a second direction crossing the first direction by each of the lights, and that guides a plurality of lights whose light sources are different from one another to positions different from one another in the first direction on the photosensitive surface;
a light concentrating section that concentrates the lights which are emitted from the plurality of light sources and which are guided to the photosensitive surface by the scanning optical system, on the photosensitive surface, and that also has a function to adjust a light concentrating position to a light traveling direction;
a light receiving device to which a plurality of lights whose light sources are different from one another are guided and emitted from a part of a movement range of light that moves along with scanning by the scanning optical system so as to receive separately the plurality of lights, which includes a plurality of light receiving parts to detect a received light quantity of each of the lights, and in which an optical path length to the light receiving part is greater than the optical path length to the photosensitive surface as for a part of the plurality of lights that pass through on the plurality of light receiving parts along with the scanning, and the optical path length to the light receiving part is smaller than the optical path length to the photosensitive surface as for another part of the plurality of lights; and
a light concentrating position adjusting section that uses the function of the light concentrating section to adjust the light concentrating position by the light concentrating section based on the received light quantity detected by each of the plurality of light receiving parts included in the light receiving device.

2. The exposure apparatus according to claim 1, further comprising
a light guiding section that is arranged at one end of the movement range of the light moving along with the scanning by the scanning optical system and that guides light which reaches the one end in a light guiding direction crossing both a moving direction in which the light moves by the scanning and a traveling direction in which the light travels, wherein
the light receiving device is arranged up-front in a direction from the light guiding section to the light guiding direction.

3. The exposure apparatus according to claim 1, wherein
the light receiving device includes three or more light receiving parts and receives separately three or more lights whose light sources are different from one another, wherein the optical path length up to the light receiving part is equal to the optical path length up to the photosensitive surface as for a first light of the plurality of lights, the optical path length up to the light receiving part is greater than the optical path length to the photosensitive surface as for a second light of the plurality of lights, and the optical path length to the photosensitive surface is smaller than the optical path length up to the photosensitive surface as for a third light of the plurality of lights.

4. An image forming apparatus comprising:
a plurality of light sources each of which emits light;
a photoreceptor that includes a photosensitive surface on which an image is drawn by receiving illumination of a light and in which at least the photosensitive surface moves in a first direction along the photosensitive surface;
a scanning optical system that guides each of the lights emitted from the plurality of light sources to the photosensitive surface included in the photoreceptor to scan the photosensitive surface in a second direction crossing the first direction by each of the lights and that guides a plurality of lights whose light sources are different from one another to positions different from one another in the first direction on the photosensitive surface;
a light concentrating section that concentrates the lights which are emitted from the plurality of light sources and which are guided to the photosensitive surface by the scanning optical system, on the photosensitive surface, and that also has a function to adjust a light concentrating position to a light traveling direction;
a light receiving device to which a plurality of lights whose light sources are different from one another are guided and emitted from a part of a movement range of light that moves along with scanning by the scanning optical system so as to receive separately the plurality of lights, which includes a plurality of light receiving parts to detect a received light quantity of each of the lights, and in which an optical path length to the light receiving part is greater than the optical path length to the photosensitive surface as for a part of the plurality of lights that pass through on the plurality of light receiving parts along with the scanning, and the optical path length to the light receiving part is smaller than the optical path length to the photosensitive surface as for another part of the plurality of lights; and
a light concentrating position adjusting section that uses the function of the light concentrating section to adjust the light concentrating position by the light concentrating section based on the received light quantity detected by each of the plurality of light receiving parts included in the light receiving device; and
a transferring and fixing section that transfers and fixes the toner image formed by the toner image forming section to a recording medium.

5. The exposure apparatus according to claim 2, wherein
the light receiving device includes three or more light receiving parts and receives separately three or more lights whose light sources are different from one another, wherein the optical path length up to the light receiving part is equal to the optical path length up to the photosensitive surface as for a first light of the plurality of lights, the optical path length up to the light receiving part is greater than the optical path length to the photosensitive surface as for a second light of the plurality of lights, and the optical path length to the photosensitive surface is smaller than the optical path length up to the photosensitive surface as for a third light of the plurality of lights.
